(19) United States
(12) Patent Application Publication
(10) Pub. No.: US 2007/0111608 A1
(43) Pub. Date: May 17, 2007

(54) Duplex-type connector

(76) Inventor: Chien-Pin Huang, Taipei (TW)

Correspondence Address: TROXELL LAW OFFICE PLLC;SUITE 1404, 5205 LEESBURG PIKE, FALLS CHURCH, VA, 22041, US

(21) Appl. No.: 11/274,160

(22) Filed: Nov. 16, 2005

(51) Int. Cl. H01R 24/00

(52) U.S. Cl. 439/676

(57) ABSTRACT

A duplex-type connector selects to perform matching connection to a first specification slot and a second specification slot respectively. The duplex-type connector includes a main body and a rotating connection portion. The main body has a connecting portion equipping at the outer edge thereof and a connecting port corresponding to the dimension of the first specification slot to be capable of performing matching connection thereto. The rotating connection portion being connected to the connecting portion is capable of performing a rotating and flapping actions by the use of the connecting portion as a pivot. As the rotating connection portion approaches and contacts the distal of the end of the main body, the main body is capable of selecting to perform matching connection to the second specification slot that has a relatively larger hole. In this way, a single connector is capable of applying in two kinds of slot having different specifications. What is more, the rotating and flapping actions of the above-mentioned connecting portion is capable of effectively reducing the size of the main body structure.

### BACKGROUND OF THE INVENTION

1. Field of the Invention

The invention relates to a duplex-type connector, and more particularly, to a duplex-type connector that can be used in two different kinds of slot having two different specifications respectively.

2. Description of the Prior Art

Science and technology change with each passing days. Following the popularization of the personal computer as well as the flourishing of the 3C-product, the peripherals having various specifications, components such as joints, sockets, and signal cables having different shapes and specifications, weed through the old and to bring forth the new. These components being independent and not compatible one another oftentimes cause inconvenient to the users

Furthermore, transmission cables like telephone cables employing RJ 11 joint can provide network connection for connecting a MODEM while employing RJ 45 joint can provide network card for connecting a Local Area Network (LAN). In general, since the number of wire of the core of each cable is different, and since the shape of the joint and the location of connecting point of the terminal are all different, these transmission cables cannot share one another. What is more, the fact that the multiplicity of transmission cables occupying the limited space oftentimes cause inconvenient for the users to store up, and increase the cost for the consumers.

FIG. 1A and FIG. 1B are schematic pictorial views of the structure of duplex-type connector on the market combining the use of the above-mentioned two kinds of joint of the prior art. The first specification slot (1) connected to the telephone cable on the market has 6 through-slot equipping 4 signal-connecting-cable terminals while the second specification slot (2) connected to the network has 8 through-slot equipping 8 signal-connecting-cable terminals. Therefore, the width dimension “w1” of the first specification slot (1) is smaller than the width dimension “w2” of the second specification slot (2) while their heights “h” are the same. The duplex-type connector (3) on the market makes use of a slide cover (31) disposed thereon to combine with the end portion (32) of the duplex-type connector (3) to make the end portion (32) form a corresponding width dimension “w2” of the second specification slot (2) to be able to further closely connect to the second specification slot (2). As the slide cover (31) slides back to separate from the end portion (32) of the duplex-type connector (3), the end portion (32) forms a corresponding width dimension “w1” of the first specification slot (1). Besides, since the duplex-type connector (3) has an in-row band cable (34) that might touch the slide cover (31), a design that makes use of a stopper (not shown in the Figure) to secure on the duplex-type connector (3) is required.

The duplex-type connector (3) of the prior art has the following demerits:
1. As the slide cover needs to be manually pulled or pushed to move back and forth, a relatively longer length of the duplex-type connector is required to be designed. Consequently, the manufacturing cost and the occupied space will be increased.
2. As the dimension of the heights “h” are the same, it is necessary to have the connecting link (33) of the slide cover (31) disposed at the end portion thereof. But since the slide cover (31) is a plastic injection molded product, frequent use of the product not only can make the leading edge deform because of its propping up to insert into the slot, but can damage the slide cover (31) as well in the worst situation.

Therefore, it has been an urgent plan and improvement project for the manufacturers to resolve the above-mentioned problems.

### SUMMARY OF THE INVENTION

In light of the above-mentioned demerits of the prior art, the invention provides a duplex-type connector that aims to ameliorate at least some of the demerits of the prior art or to provide a useful alternative.

The primary objective of the invention is to provide a duplex-type connector that makes use of connecting a rotating connection portion to change the outer edge's dimension of the connecting port of the connector to achieve the efficacy of using a single connector in two different specification slots.

The secondary objective of the invention is to provide a duplex-type connector that makes use of a rotating connection portion to connect to the outer edge of the connector by the way of rotation to achieve the efficacy of effectively reducing the size of the connector.

In order to achieve the above-mentioned objectives, a duplex-type connector of the invention is provided to select to perform matching connection to a first specification slot and a second specification slot respectively. The duplex-type connector includes a main body and a rotating connection portion. The main body has a connecting portion equipping at the outer edge thereof and a connecting port corresponding to the dimension of the first specification slot to be capable of performing matching connection thereto. The rotating connection portion being connected to the connecting portion is capable of performing a rotating and flapping actions by the use of the connecting portion as a pivot.

The accomplishment of this and other objectives of the invention will become apparent from the following description and its accompanying drawings of which:

### BRIEF DESCRIPTION OF THE DRAWINGS

FIG. 1A and FIG. 1B are schematic pictorial views of the structure of duplex-type connector on the market of the prior art.

FIG. 2A and FIG. 2B are schematic pictorial views of the structure of a duplex-type connector of the invention.

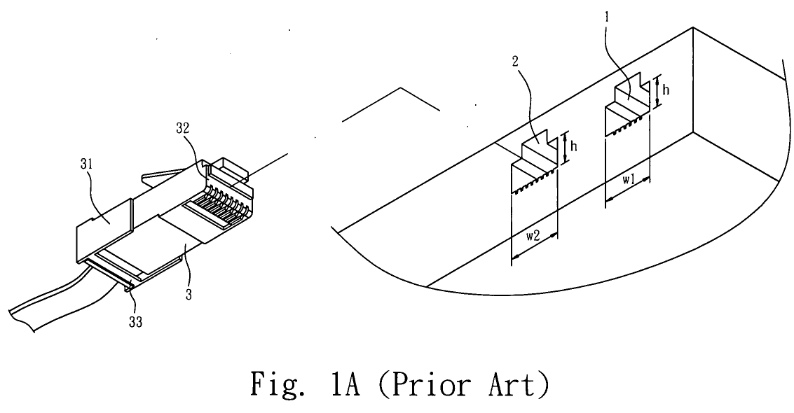

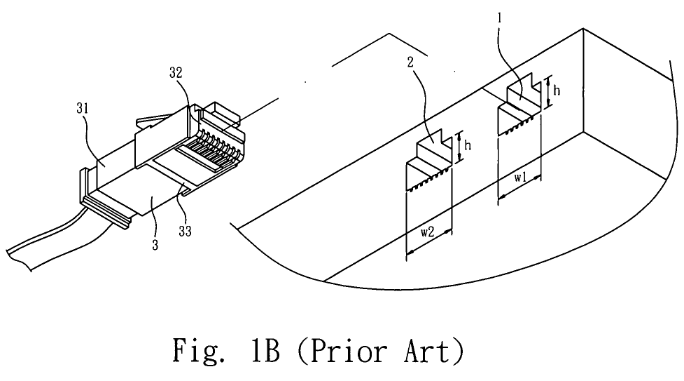

### DETAILED DESCRIPTION OF THE PREFERRED EMBODIMENT

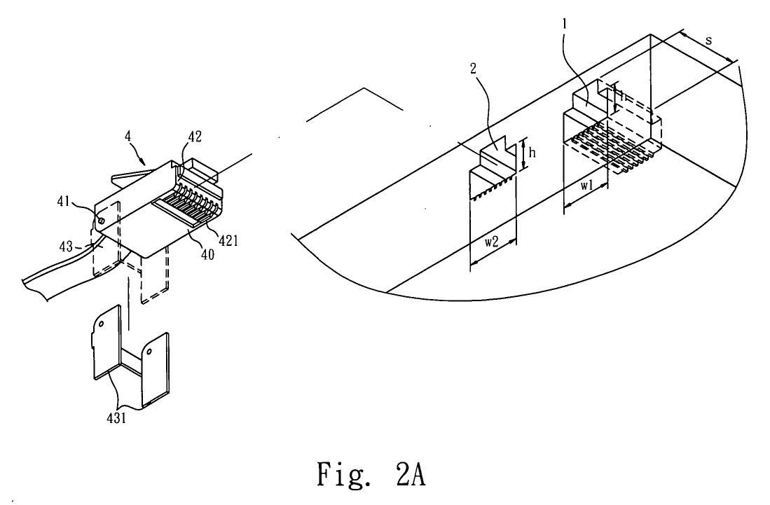

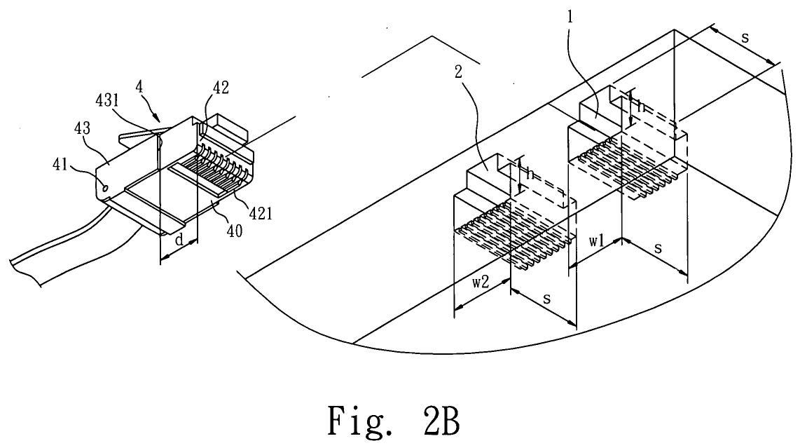

FIG. 2A and FIG. 2B are schematic pictorial views of the structure of a duplex-type connector of the invention. As shown in FIG. 2A and FIG. 2B, the duplex-type connector (4) of the invention respectively selects and connects to a first specification slot (1) of the telephone cable as well as selects and connects to a second specification slot (2) of the network cable to perform matching connection. The first specification slot (1) having 6 through-slot with 4 (out of the 6) of them equipping with signal connecting cable is of RJ 11 specification while the second specification slot (2) having 8 through-slot with all of the 8 through-slot equipping with signal connecting cable is of RJ 45 specification. Therefore, the dimension of the width “w1” of the first specification slot (1) is smaller than that of the width “w2” of the second specification slot (2), while the heights “h” of the two slots are the same.

The duplex-type connector (4) includes a main body (40) and a rotating connecting portion (43). The main body (40) has a connecting portion (41) disposing at the outer edge thereof and a connecting port (42) corresponding to the dimension of first specification slot (1). If the connecting port (42) is selected to perform matching connection to the first specification slot (1), the plurality of signal terminals (421) of the connecting port (42) are exactly connected to the signal terminals of the first specification slot (1). Besides, since the connecting port (42) possesses 8 signal terminals (421), a general signal connection is formed when the main body (41) selects to electrically connect to the 4 signal connection cables of first specification slot (1).

The connection between the connecting portion (41) and the rotating connecting portion (43) is making use of the designed salient flange on the connecting portion (41) to fit to corresponding scoop hole on the rotating connecting portion (43). The same connection between the connecting portion (41) and the rotating connecting portion (43) can also make use of the hole on the connecting scoop portion (41) to fit to corresponding salient flange on the rotating connecting portion (43). Such kind of structural design change is the embodiment variation in accordance with the above-mentioned description that persons familiar with the art can easily do without departing from the important portion and the scope or spirit of the invention, thereby, it is not necessary to go into details at this moment.

It is understood from what is mentioned above that the rotating connecting portion (43) is capable of performing rotating and flapping actions with the connecting portion (41) as a pivot. Therefore, when the rotating connecting portion (43) approaches an end of the outer edge of the main body (40), the main body (40) is capable of selecting to have matching connection to the second specification slot (2) having relatively large dimension. At this moment, since an end of the rotating connecting portion (43) has an end surface (431) that has a distance “d” from the connecting port (42) and the distance “d” is relatively smaller than the extended length of the second specification slot (2), the rotating connecting portion (43) can be fully inserted into the second specification slot (2). Therefore, the 8 signal terminals (421) of the connecting port (42) can be one-to-one corresponding to and electrically connected to the 8 electrically connecting cables of the second specification slot (2). Since the connector (4) has an in-row band cable (44), the design of the rotating connecting portion (43) making use of its flapping action not only can reduce its chance to contact with the in-row band cable (44), the in-row band cable can be designed to be embedded into the connector (4) as well. Certainly, the in-row band cable (44) can be designed directly to be secured on the connector (4) making use of a cable stopper (not shown in the Figure).

The duplex-type connector of the invention not only has the efficacy of using a single connector in two different specification slots but also has the efficacy of effectively reducing the dimension of the connector since the rotating connecting portion can be connected to the outer edge of the connector by the use of its rotation. Therefore, the invention can overcome the demerits of the conventional technology, satisfy the demand of the industry, and improve the competitiveness of the product on the market.

It will become apparent to those people skilled in the art that various modifications and variations can be made to the structure of the invention without departing from the scope or spirit of the invention. In view of the foregoing description, it is intended that all the modifications and variation fall within the scope of the following appended claims and their equivalents.

What is claimed is:

1. A duplex-type connector, selecting a first specification slot and a second specification slot respectively to perform matching connection, comprising:
a main body having a connecting portion equipping at the outer ridge thereof and a connecting port, the connecting port that is one-to-one corresponding to the first specification slot is capable of performing matching connection to the first specification slot; and
a rotating connection portion connected to the connecting portion, and by the use of the connecting portion as a pivot, the rotating connection portion is capable of performing rotating and flapping actions; also the rotating connection portion being closely contacting an end of the outer edge of the main body is capable of performing matching connection to the second specification slot.

2. The duplex-type connector as claimed in claim 1 is characterized by the fact that the connecting port has a plurality of signal terminals, and the main body is electrically connected to the first specification slot and second specification slot respectively.

3. The duplex-type connector as claimed in claim 1 is characterized by the fact that the first specification slot is a socket of RJ 11 specification.

4. The duplex-type connector as claimed in claim 1 is characterized by the fact that the second specification slot is a socket of RJ45 specification.

5. The duplex-type connector as claimed in claim 1 is characterized by the fact that the connecting portion is a scoop hole while the corresponding rotating connection portion is a salient flange.

6. The duplex-type connector as claimed in claim 1 is characterized by the fact that the connecting portion is a salient flange while the corresponding rotating connection portion is a scoop hole.

7. The duplex-type connector as claimed in claim 1 is characterized by the fact that the rotating connection portion has an end surface that has a distance “d” from the connecting port.

8. The duplex-type connector as claimed in claim 1 is characterized by the fact that the distance “d” is relatively smaller than the extended length “s” of the second specification slot.
